(19) United States
(12) Patent Application Publication
(10) Pub. No.: US 2022/0070619 A1
(43) Pub. Date: Mar. 3, 2022

(54) METHOD, APPARATUS, AND SYSTEM FOR DETECTING EVENTS OR POINTS OF INTEREST BASED ON MOBILE DEVICE ORIENTATION CHANGES

(71) Applicant: HERE Global B.V., Eindhoven (NL)

(72) Inventor: Donta WHITE, Racine, WI (US)

(21) Appl. No.: 17/095,507

(22) Filed: Nov. 11, 2020

Related U.S. Application Data
(60) Provisional application No. 63/071,895, filed on Aug. 28, 2020.

(51) Int. Cl. H04W 4/029; H04M 1/725; H04W 4/02

(52) U.S. Cl. CPC H04W 4/029; H04M 1/72569; H04W 4/026; H04W 4/027; H04M 1/72572

(57) ABSTRACT

An approach is provided for detecting location-based events and/or points of interest based on mobile device orientation changes. The approach, for example, involves determining an orientation change of a mobile device moving in a geographic area based on sensor data collected from one or more sensors of the mobile device. The approach also involves determining a location of the orientation change based on the sensor data. The approach further involves detecting a map incident (e.g., a traffic accident), a map feature (e.g., a point of interest), or a combination occurring within a proximity of the location based on the orientation change.

### RELATED APPLICATION

This application claims priority from U.S. Provisional Application Ser. No. 63/071,895, entitled “METHOD, APPARATUS, AND SYSTEM FOR DETECTING EVENTS OR POINTS OF INTEREST BASED ON MOBILE DEVICE ORIENTATION CHANGES,” filed on Aug. 28, 2020, the contents of which are hereby incorporated herein in their entirety by this reference.

### BACKGROUND

Service providers and device manufacturers (e.g., wireless, cellular, etc.) are continually challenged to deliver value and convenience to consumers by, for example, providing compelling network services. One area of interest has been the creation and maintenance of mapping and location-based services for mobile device users, particularly services that respond to users' increasing expectation and demand for up-to-the-minute information. More specifically, there is an interest in providing users with current information about location-based events such as traffic, road construction, new road development, news events, public events, and the like, and points of interest (POIs). However, traditional geospatial data collection approaches can be costly or burdensome. Accordingly, service providers and device manufacturers face significant technical challenges to collecting and/or updating geospatial data such as POIs and/or location-based events.

### Some Example Embodiments

Therefore, there is a need for an approach for detecting location-based events and/or points of interest (POIs) using sensor data (including orientation changes) collected from mobile devices thereby supporting services such as but not limited to mapping services, navigation servicers, autonomous driving services, ride-hailing services, ride-sharing services, social networking services, Internet of things (IoT), industrial IoT (IIoT, e.g., Industry 4.0 architectures and infrastructures), etc. It is noted that as used herein the terms “event/POI detection” and “event/POI verification” are used interchangeably to refer to determining location-based events and/or POIs.

According to one embodiment, a method comprises determining an orientation change of a mobile device moving in a geographic area based on sensor data collected from one or more sensors of the mobile device. The method also comprises determining a location of the orientation change based on the sensor data. The method further comprises detecting a map incident, a map feature, or a combination occurring within a proximity of the location based on the orientation change.

According to another embodiment, an apparatus comprises at least one processor, and at least one memory including computer program code for one or more computer programs, the at least one memory and the computer program code configured to, with the at least one processor, cause, at least in part, the apparatus to determine an orientation change of a mobile device moving in a geographic area based on sensor data collected from one or more sensors of the mobile device. The apparatus is also caused to determine a location of the orientation change based on the sensor data. The apparatus is further caused to detect a map incident, a map feature, or a combination occurring within a proximity of the location based on the orientation change.

According to another embodiment, a computer-readable storage medium carries one or more sequences of one or more instructions which, when executed by one or more processors, cause, at least in part, an apparatus to determine an orientation change of a mobile device moving in a geographic area based on sensor data collected from one or more sensors of the mobile device. The apparatus is also caused to determine a location of the orientation change based on the sensor data. The apparatus is further caused to detect a map incident, a map feature, or a combination occurring within a proximity of the location based on the orientation change.

According to another embodiment, an apparatus comprises means for determining an orientation change of a mobile device moving in a geographic area based on sensor data collected from one or more sensors of the mobile device. The apparatus also comprises means for determining a location of the orientation change based on the sensor data. The apparatus further comprises means for detecting a map incident, a map feature, or a combination occurring within a proximity of the location based on the orientation change.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of detecting location-based events and/or points of interest based on mobile device orientation changes, according to one embodiment;

FIG. 2A is a diagram illustrating an example location-based event and an example point of interest seen from a driver's perspective, according to one embodiment;

FIG. 2B is a diagram illustrating the example location-based event and the example point of interest shown on a map, according to one embodiment;

FIG. 3 is a diagram of components of a maps platform, according to one embodiment;

FIG. 4 is a flowchart of a process for detecting location-based events and/or points of interest based on mobile device orientation changes, according to one embodiment;

FIGS. 5A-5D are graphs illustrating examples of mobile device orientation changes, according various embodiments;

FIGS. 6A and 6B are diagrams of example user interfaces for providing mapping and/or navigation services based on detected map incidents/features, according to various embodiments;

FIG. 7 is a diagram of a geographic database, according to one embodiment;

FIG. 8 is a diagram of hardware that can be used to implement an embodiment;

FIG. 9 is a diagram of a chip set that can be used to implement an embodiment; and

FIG. 10 is a diagram of a mobile terminal that can be used to implement an embodiment.

### DESCRIPTION OF SOME EMBODIMENTS

Examples of a method, apparatus, and computer program for detecting location-based events and/or points of interest based on mobile device orientation changes are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

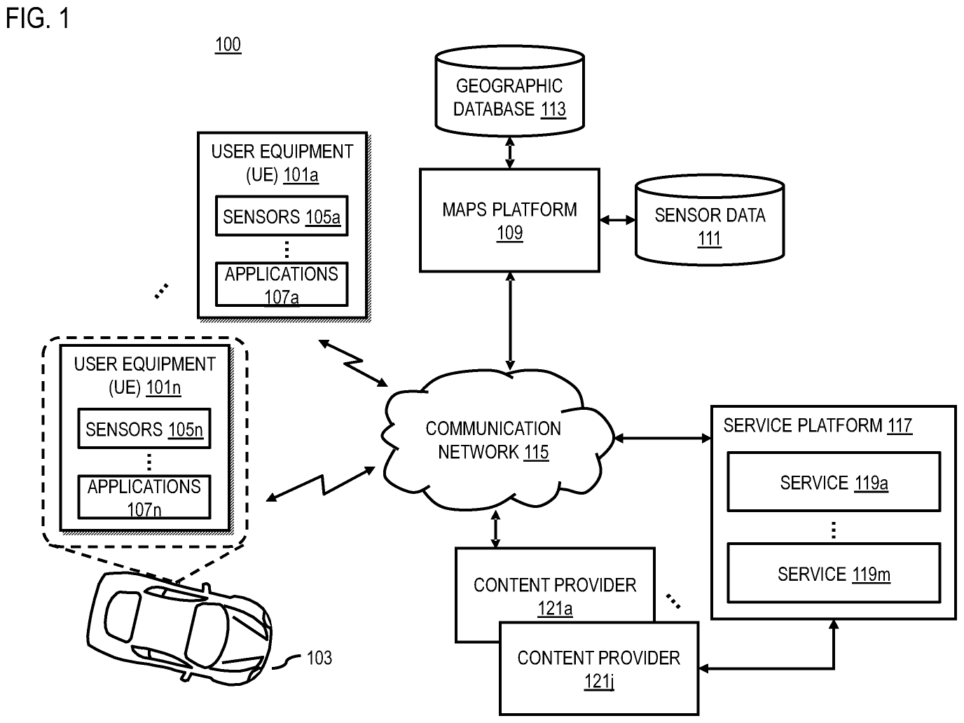

FIG. 1 is a diagram of a system 100 capable of detecting location-based events and/or points of interest based on mobile device orientation changes, according to one embodiment. As previously discussed, service providers and devices manufacturers are interested in developing and improving mapping and location-based services for mobile device users, particularly services that respond to users' increasing demand for up-to-the-minute information. However, location-based events (e.g., transient events such as traffic, accidents, public gatherings, etc.) and the number of new, closed, or updated POIs are ever changing. To keep up with these changes, field workers may have to manually detect and take note of any potential changes. For instance, a road closure is verified by contacting a police and/or first-responder communication center, or with visibility of the road incident/closure on a camera, in conjunction with other verification processes. By way of example, verifying real-time traffic closures and incidents is a difficult task that utilizes traffic editors/traffic quality specialists to verify traffic incidents in real-time on global road networks in affected areas. However, the amount of stationary (e.g., on light poles) cameras as well as police and first responder resources can be limited or non-existent in the affected areas.

On the other hand, the existing location aware/location intelligence approaches automatically detect road incidents and road closures using road sensor data as well as probe data collected and/or gathered from network-connected mobile devices that are moving in affected areas. However, the amount of probe data and sensor data can be limited or non-existent in the affected areas.

To address this problem, the system 100 of FIG. 1 introduces the capability to automatically detect location-based events and/or new POIs by using mobile device orientation changes. In one embodiment, the system 100 can detect a rapid or abrupt change in the orientation of one or more user equipment (UE) devices 101a-101n (also referred to as UEs 101—such as smart phones with cameras), and use location information transmitted by the UEs 101 to identify a geographical area where the UEs 101 is concentrated and a location-based event (e.g., a traffic accident) or POI (e.g., a new monument) that attracts the UEs 101 to change their orientations and capture images. The UEs 101 can be carried by a user, a vehicle 103 (e.g., car, bus, train, airplane, boat, etc.), or a combination thereof.

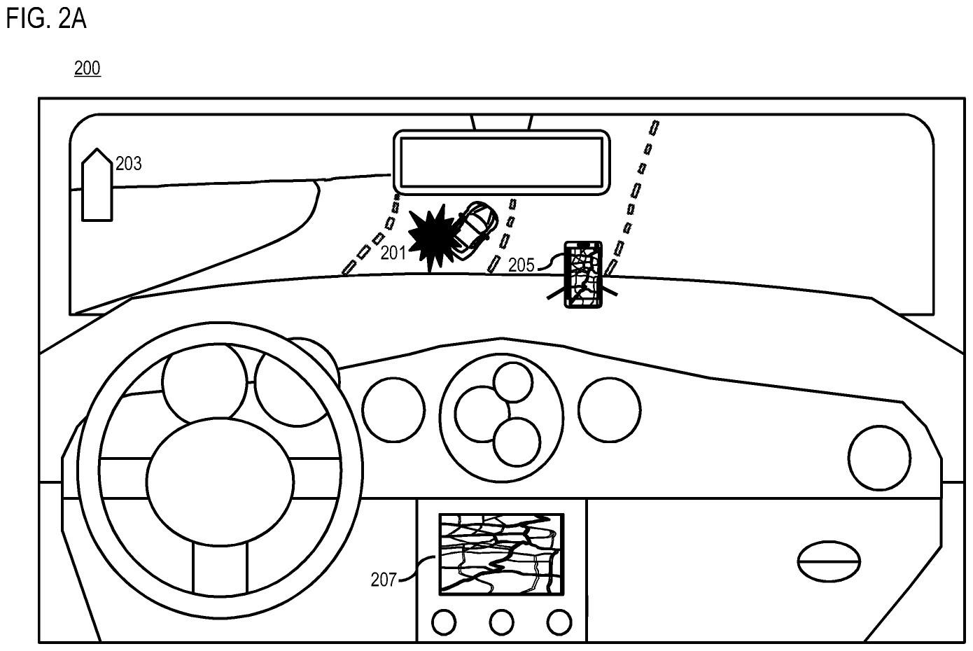

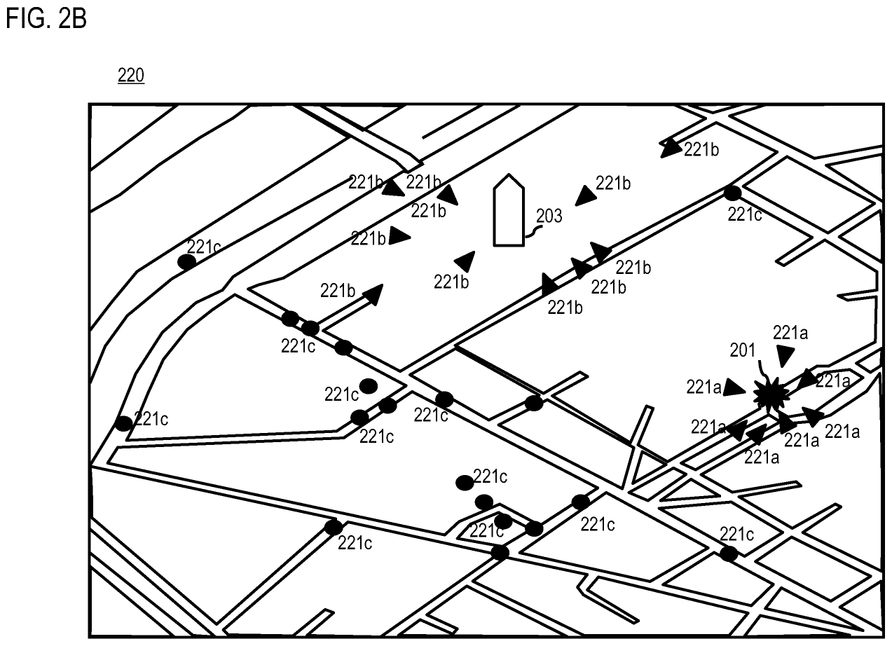

The UEs 101 can be phones, tablets, personal digital assistants (PDAs), smart watches, navigation devices, drones, smart glasses, vehicle-mounted cameras, smart clothing with camera, body-worn cameras, hands-free cameras, as well as other network-connected probe devices that are travelling in the affected area.” FIG. 2A is a diagram 200 illustrating an example location-based event and an example point of interest seen from a driver's perspective, according to one embodiment. The cause of the mobile device orientation changes could be a slowdown or stoppage on a street or road because a traffic incident, a road closure, a POI, and/or any action that compel an object, vehicle, or person, that is travelling through an area, to capture images.

For instance, traffic was flowing smoothly on a road through a downtown area, and then suddenly, an accident occurs involving vehicles. There are no traffic cameras along this stretch of the road. As first responders are heading to the accident scene, north-east-bound lanes is entirely blocked; however, traffic is getting by on the left shoulder and is pooling up behind the accident. Various vehicles traveling in the north-east-bound direction are attempting to pass the accident before the police arrive. Meanwhile, south-west-bound vehicles are also slowing down and “rubber-necking,” to view the accident scene on the north-east-bound lanes. Due to the slowdown, drivers in both directions are recording the accident as they pass the incident on the westbound side, and/or the left shoulder on the eastbound side.

Drivers with dash cameras can moved their cameras, changed the orientations of the camera to capture images of the incident. Meanwhile, passengers who may have been surfing the web, leaning-in, and looking down at their mobile devices, now start changing the device orientations from a vertical (standing) orientation to a horizontal (flat) orientation to capture images of the incident. By way of example, in FIG. 2A, when a driver of the vehicle 103 notices a car accident 201 and/or a new monument 203, the driver can use a smart phone 205 and/or a vehicle-mounted camera (which can be a front and/or rear camera connected to vehicle dashboard display 207) to capture images of the car accident 201 and/or the new monument 203.

FIG. 2B is a diagram illustrating the example location-based event (e.g., the car accident 201) and the example point of interest (e.g., the new monument 203) shown on a map 220, according to one embodiment. As shown in FIG. 2B, the system 100 can detect and/or verify the presence of a location-based event (e.g., a traffic incident or traffic closure like the car accident 201) based on the orientation arrow marks 221a associated with some UEs made orientation changes, and/or a POI (e.g., the new monument 203) using the orientation arrow marks 221b associated with other UEs made orientation changes. FIG. 2B also shows dot marks 221c associated with the remaining UEs that do not capture images in response to location-based events and/or POIs.

Sensors from the UEs 101 that changed orientations in this area can be uploaded in real-time, plotted on a map as a layer, and/or used by the system 101 to verify traffic incidents/closures accurately and faster in areas with limited traffic cameras, probe data, sensor data, limited first responders, and/or first responders with latency issues.

In one embodiment, the UEs 101 contain sensors 105a-105n (collectively referred to as sensors 105 of different types that sense different characteristics) and applications 107a-107n (collectively referred to as applications 107, such as mapping/location-based application). In one embodiment, the system 100 can process sensor data collected by sensors of the UEs 101, the vehicle 103, etc., to determine that a status of at least one of the UEs 101 as being: (1) placed close to a window of the one or more vehicles within a threshold distance during the orientation change, (2) orientated in parallel with the window after the orientation change, (3) held out of the window after the orientation change, (4) switched from a sleep mode to an imaging-capturing mode during the orientation change, etc. The sensors can include air flow sensors, sound sensors, etc. that detect a UE is held out of the window. The applications 107 can enable the UEs 101 to access the event and/or POI information determined by the system 100 and subsequently provisioned by location-based services.

In another embodiment, the system 100 can apply the same approach to a public event (e.g., a concert, parade, fireworks, etc.) at a venue and the audience members are recording the event, and/or unreported road closures in and around the venue. In yet another embodiment, the system 100 can apply the same approach to indoor mapping and/or navigation.

The system 100 can detect rapid and/or abrupt changes in orientation of one or more network-connected UEs 101 (e.g., mobile phones, cellphones, smart watches, drones, glasses, dashboard cameras, GOPRO® devices, etc.) that are dynamically moving in an area and verify map incidents/features in that area (such as presence of a traffic/road incident, traffic/road closure, accidents, POI etc.). The cause of the orientation changes could be a slowdown or stoppage on a street or road due to the occurrence of the map incidents/features (such as traffic incident and/or road closure, POI, and/or any action) that compels an object, vehicle, or person, that is dynamically moving through the area, to record using the devices (e.g. image capturing recording device).

As shown in FIG. 1, the UEs 101 are connected to a maps platform 109 (that is connected to a sensor database 111 and a geographic database 113), via a communication network 115. The UEs 101 also have connectivity to a service platform 117 that includes one or more services 119a-119m (also collectivity referred to as services 119) for providing mapping and/or location-based services. In one embodiment, the service platform 117 and/or services 119 interact with one or more content providers 121a-121j (also collectively referred to as content providers 121) to provide mapping information or user generated content information to the maps platform 109.

In one embodiment, the maps platform 109 performs the functions of detecting events and/or POIs as discussed with respect to the various embodiments described herein. By way of example, the maps platform 109 may exist independently or within a cloud computing and/or cloud storage platform, and apply edge computing. Further, in one example, a user may use a UE 101 in order to both communicate map-related information within the services 119 (e.g., social network services) as well as receive the incident and/or POI data generated by the maps platform 109 and stored in the geographic database 113.

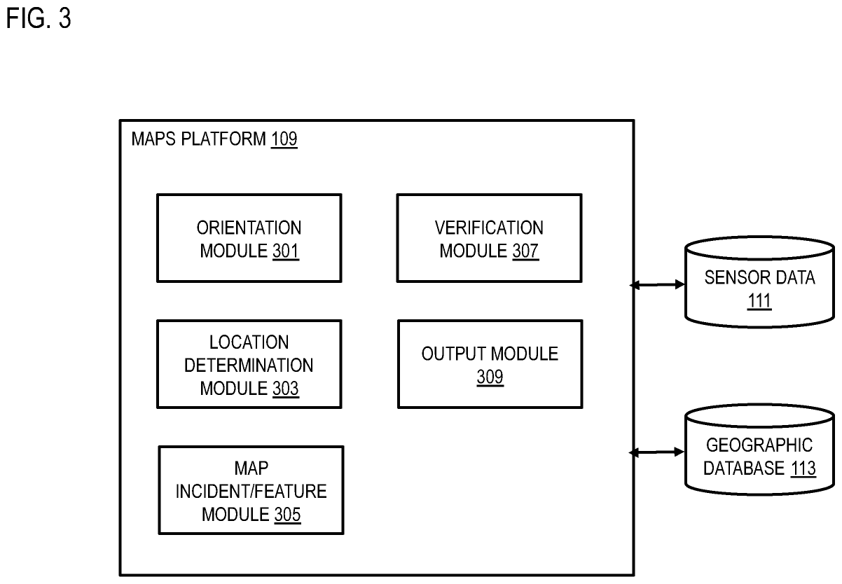

FIG. 3 is a diagram of the components of a maps platform 109, according to one embodiment. By way of example, the maps platform 109 includes one or more components for computing a parking score based on a risk of hindering parking space usage according to the various embodiments described herein. It is contemplated that the functions of these components may be combined or performed by other components of equivalent functionality. In this embodiment, the maps platform 109 includes an orientation module 301, a location determination module 303, a map incident/feature module 305, and a verification module 307, and an output module 309. The above presented modules and components of the maps platform 109 can be implemented in hardware, firmware, software, or a combination thereof. Though depicted as a separate entity in FIG. 1, it is contemplated that the maps platform 109 may be implemented as a module of any of the components of the system 100 (e.g., a component of the vehicle 101, navigation system of the vehicle 101, user equipment (UE) 101, and/or application 107 in UE 101). In another embodiment, one or more of the modules 301-309 may be implemented as a cloud based service, local service, native application, or combination thereof. The functions of these modules are discussed with respect to FIGS. 3-6 below.

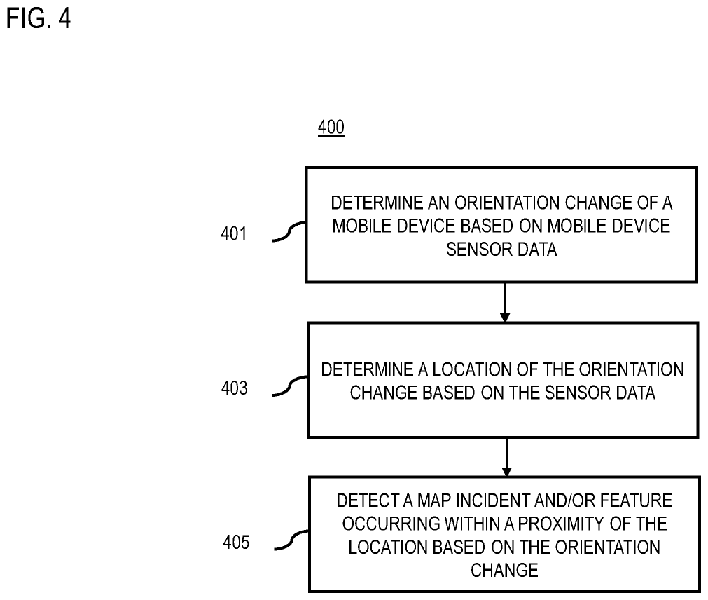

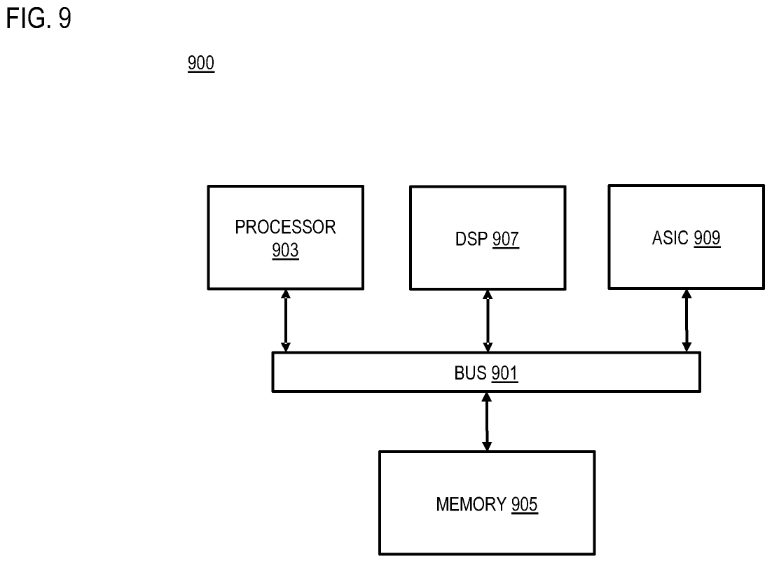

FIG. 4 is a flowchart of a process for detecting location-based events and/or points of interest based on mobile device orientation changes, according to one embodiment. In various embodiments, the maps platform 109 and/or any of the modules 301-309 of the maps platform 109 as shown in FIG. 3 may perform one or more portions of the process 400 and may be implemented in, for instance, a chip set including a processor and a memory as shown in FIG. 9. As such, the maps platform 109 and/or any of the modules 301-309 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all of the illustrated steps.

In one embodiment, in step 401, the orientation module 301 can determine an orientation change of a mobile device (e.g., UE 101) moving in a geographic area based on sensor data collected from one or more sensors of the mobile device. The sensor data can be stored in the sensor database 111, the geographic database 113, or a combination thereof, and optionally protected via blockchain technology that offers users full control over their information.

In one embodiment, the location information, and/or the orientation change of the UE101 can be determined by an inertial measurement unit (IMU) and/or a traditional sensor such as but not limited to Global Positioning Satellite (GPS) or other Global Navigation Satellite System (GNSS). By way of example, an IMU's gyroscope can measure an orientation change of the UE 101, and an IMU's magnetometer can measure an orientation of the UE 101.

In another embodiment, the location information, and/or the orientation change of the UE101 can be determined from probe data, for example, retrieved from the geographic database 113. Probe data, for instance, can include geolocation information (e.g., geographic coordinates, heading, speed, etc.) recorded by the UE 101 and transmitted to the system 100. In some embodiments, the system 100 can obtain the location information and/or the orientation change via other means such as network triangulation or usage. For example, the system 100 can determine the number of devices connected to a WiFi network with a known location or the number of devices in a communication cell of a cellular network. It is contemplated that the system 100 may use any means or metric to determine the number or density of UE 101 at various locations for processing according to the various embodiments described herein.

Referring back to FIG. 2B, the UE 101 can be carried by a user walking around the monument 203, or in the vehicle 103 stopping in the traffic, such that the orientation change of the UE 101 equals to the orientation change made by the user with respect to the ground. In another instance, when the UE 101 is carried by the vehicle 103 that is moving and/or turning, the orientation module 301 can process the sensor data and/or probe data to factor a vehicle movement of the vehicle 103 in a user movement of the UE 101 as a cause of the orientation change, such as filtering the vehicle movement from the user movement or vis versa, to determine the orientation change made by the user with respect to the ground. The detecting of the map incident, the map feature, or a combination thereof is based on the orientation change resulting from the user movement. By way of example, a driver of the vehicle 103 turns the smart phone 205 left 15 degrees towards the monument 203 while bearing left 30 degrees to get around the traffic caused by the accident 201 to capture an image of the monument 203. In this case, the system 100 determines the total orientation changes as 45 degrees from the road the vehicle 103 traveling on.

In one embodiment, in step 403, the location determination module 303 can determine a location of the orientation change based on the sensor data as discussed above. The determining of the location of the orientation change can be further based on a direction (e.g., left), a focal point, or a combination thereof of the orientation change. By way of example, a focal point can be pointed towards by a plurality of UE 101, such as the car accident 201 being a focal point of the orientation arrow marks 221a associated with some UEs made orientation changes, and the monument 203 being a focal point of the orientation arrow marks 221b associated with other UEs made orientation changes in FIG. 2B.

In one embodiment, in step 405, the map incident/feature module 305 can detect a map incident (e.g., a traffic incident), a map feature (e.g., a POI), or a combination occurring within a proximity of the location based on the orientation change. By way of example, a map incident can be a traffic incident, a road closure, a traffic jam, a firework event, a parade, a building fire, etc., and a map feature can be a point of interest, a natural feature, terrain, etc., (whatever features stored in the geographic database 113). By way of example, a firework event occurs near a road but not on the road. Riding through this area, a passenger can capture this event as a video with continuous orientation changes, although the traffic flow remains stable. When the map incident/feature module 305 detects orientation changes of a plurality of UEs 101 in this area, map incident/feature module 305 can determine the firework event by analyzing the image data, user interaction activity data with the UEs (e.g., social network posting), other contextual data (e.g., news), etc.

In one embodiment, the map incident/feature module 305 can discover map incidents/features from the UE location points and respective orientation changes. By way of example, for each time period for the UEs 101, the map incident/feature module 305 retrieves a list of location points lp=(p1, p2, . . . , pN), where N is the number of location points for the UEs 101. In one embodiment, a location point pi is defined using: pi=(lat, long, alt, h, c, T) corresponding to latitude, longitude, altitude, a heading h, an orientation change c, and/or and a timestamp T. The map incident/feature module 305 can cluster location points using (but are not limited to) a clustering algorithm (e.g., a density-based method, a grid-based method, etc.) in conjunction with machine learning algorithms such as hidden Markov model, classifiers such as decision trees and their variants, auto-regressive linear models, deep neural networks (DNN), and/or equivalent, to detect map incidents/features based on contextual data such as geotagged user generated content including images, social networking communications/posts, etc. The underlying assumption here is that close-proximity among UEs 101 for a period (e.g., a period longer threshold duration) is a characteristic of a map incident/feature.

In one embodiment, the map incident/feature module 305 can process the sensor data to detect an activation of an image recording device (e.g., a camera) of the mobile device. The detecting of the map incident, the map feature, or a combination thereof is further based on the detected activation of the image recording device. By way of example, the image data can include image metadata such as image attributes (e.g., height and width in pixels, a compression type, etc.), content metadata (e.g., the content of an image, author, location, orientation, date, and time when an image was taken, etc.), etc. The map incident/feature module 305 can use the content of an image, location, orientation, etc., to determine the orientation change of the UE 101. For example, the map incident/feature module 305 can determine from the image taken location and/or orientation about an orientation change of the UE 101 and a location of the orientation change. In another embodiment, the map incident/feature module 305 can use the content of an image, author, location, orientation, etc., to determine a map incident/feature. For example, the map incident/feature module 305 can determine from the user's note in the image content about a traffic accident. In yet another embodiment, the map incident/feature module 305 can process content data of the image data to recognize a map incident/feature using computer vision, artificial intelligence, etc.

In another embodiment, the map incident/feature module 305 can use commercially available tools developed for monitoring and analyzing various social networks for marketing, promotions, and customer services purposes (e.g., RADIAN6®, KANA®, VISIBLE®, etc.), to recognize a map incident/feature. By way of example, the map incident/feature module 305 can apply a linguistic analysis of the communication data (e.g., map, traffic, POI, location-based and location related keywords and phrases). For example, one or more communications within the social network services of the UE 101 are related to a car accident on 15^{th} Street in downtown Washington D.C.

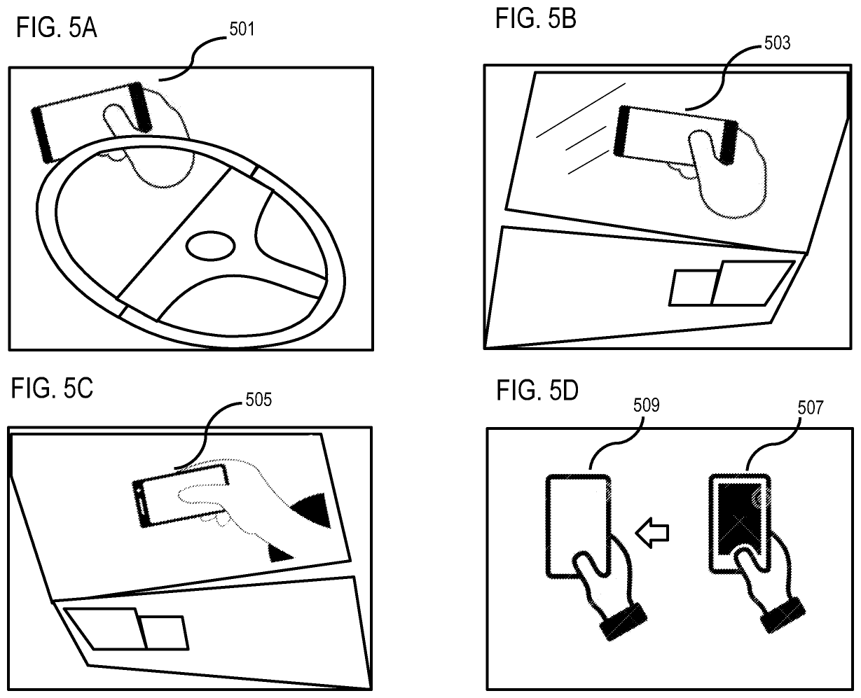

FIGS. 5A-5D are graphs illustrating examples of mobile device orientation changes, according various embodiments. In one embodiment, the map incident/feature module 305 can process the sensor data (e.g., accelerometers, gyroscopes, magnetometers, barometers, etc.) to detect an alignment of the mobile device with respect to a plane of a window of a vehicle carrying the device. By way of example, FIG. 5A shows a driver aligns the mobile device 501 with respect to a windshield of a vehicle. As another example, FIG. 5B shows a passenger aligns the mobile device 503 with respect to a window of the vehicle. The detecting of the map incident, the map feature, or a combination is further based on the detected alignment.

For instance, when one UE is parallel with a window, a scan can be made for another UE with similar orientation changes near the first UE. In this case, multiple UEs are aligned with windows in the vehicle 103 while capturing images of the same outside event about the same time. The scan can be done via Bluetooth and/or Near Field Communication (NFC). By way of example, two Bluetooth or NFC equipped UEs 101 (e.g., the smart phone 205 and the vehicle-mounted dashboard display 207 in FIG. 2B) can sense the received signal strength indication (RSSI) or NFC of each other that can be converted into a distance change when the smart phone 205 is moved to be aligned with the windshield or the window. In another embodiment, acoustics sensors can be used to detect a distance change when the smart phone 205 is moved to be aligned with the windshield or the window.

In another embodiment, the map incident/feature module 305 can process the sensor data (e.g., air flow sensors, sound sensors, etc.) to detect a movement that extends the mobile device from inside a vehicle to outside the vehicle before initiating an image recording mode on the mobile device. By way of example, the sensor data can detect an air pressure change, wind noise, etc. that associated with the opening the window to extend the mobile device outside of the vehicle. The wind can hit a speaker of the UE 101 while the vehicle is moving, and/or the up/down wind speed changes while the UE 101 is capturing images. In one embodiment, an orientation change and a pressure change can be detected in the vehicle's cabin because of vehicle's window opening before UE 101 moved out of the window (to capture images). FIG. 5C shows a passenger extends the mobile device 505 from inside a vehicle to outside the vehicle, in order to capture images of a map incident/feature. In FIG. 5C, a passenger extends one hand/arm out of the window (more horizontally in x-axis and y-axis) to post UE 101 closer to a map incident/feature on a side/peripheral area. The detecting of the map incident, the map feature, or a combination thereof is further based on the detected movement.

In another embodiment, a passenger extends one hand/arm upward (mostly vertically in z-axis) through a sunroof/moonroof, to capture a map incident/feature in front of or behind the vehicle. In either window or sunroof case, the map incident/feature module 305 can determine based on the user device probe data the directions of the movement with respect to dimensions and positions of the window or the sunroof/moonroof. As to the air pressure change and wind noise, the wind hitting on a side of the UE 101 when extended out of the window would have different impacts from the wind hitting the front/back of the UE 101 when extended upward through the sunroof/moonroof.

In another embodiment, the map incident/feature module 305 can process the sensor data (e.g., a button, a touch screen, etc. of the UE 101) to detect a change in user interaction activity data with the mobile device in combination with the orientation change. For instance, the user interaction activities with the UE 101 can include activating the mobile device from a sleep mode (e.g., a black/locked screen) 507 to an image recording mode 509 as shown in FIG. 5D. As another instance, the UE 101 is in use (e.g., web surfing, facetime, etc.), then suddenly the camera is turned on to record/capture images. The detecting of the map incident, the map feature, or a combination thereof is further based on the detected user interaction activity data.

Besides capturing images, other examples of user interaction activities with the UE 101 can include postings and/or communications exchanged within one or more social networks (e.g., FACEBOOK®, TWITTER®, YOUTUBE®, etc.). This content information of postings and/or communications can be parsed (e.g., collect, extract, analyze) or mined to determine whether they are related to or mention specific map incidents and/or POIs. The incident and/or POI related information can then be used to detect/verify map incidents and/or POIs, or to update existing map incidents and/or POIs.

In one embodiment, the detecting of the map incident, the map feature, or a combination thereof is further based on orientation change data collected from one or more other mobile devices moving with a threshold proximity, a threshold time period, or a combination thereof. Referring back to FIG. 2B, UEs 101 that are moving with a threshold proximity (from the traffic accident 201) and/or within a threshold time period, as well as making orientation changes are represented by the orientation arrow marks 221a, UEs 101 moving with a threshold proximity (from the monument 203) and/or within a threshold time period are represented by the orientation arrow marks 221b.

By analogy, the above-described embodiments can be applied to an indoor environment to detect a map incident/feature. In one embodiment, the detected map incident, the detected map feature, or a combination thereof relates to indoor mapping (e.g., a home, an office, a building, a mall, an exhibition hall, a underground public transportation system, etc.). With indoor mapping data retrieved from the geographic database 113, the system 100 device can apply orientation changes in indoor venues (e.g., concerts, sports, etc.) the same way, to determine map incidents (e.g., a drunk fan) and/or map features (e.g., a popup food stand) to support security efforts, predict trouble spots, prevent incidents from occurring, etc. The indoor venues may accommodate thousands of people who are connected to a WIFI network that can assist orientation changes.

In another embodiment, the map incident/feature module 305 can process sensor data collected by one or more sensors of a mobile device moving in a geographic area, to detect at least one of: an alignment of the mobile device with respect to a plane of a window of a vehicle carrying the mobile device, a movement that extends the mobile device from inside the vehicle to outside the vehicle. By way of example, when a user is using UE 101 to record and/or take pictures in a venue such as a basketball game or a concert (either indoors or outdoors), the common handling of the UE 101 would be to hold it close enough to see what the user is capturing. However, when an event spontaneously happens near the user, and such spontaneous event is compelling enough to cause the user to extend one arm and change the orientation of the UE 101 to capture the spontaneous event.

The map incident/feature module 305 can determine a location of the alignment, the movement, or a combination thereof based on the sensor data, and detect a map incident, a map feature, or a combination occurring within a proximity of the location based on the alignment, the movement, or a combination thereof. For instance, the map incident/feature module 305 can process the sensor data to detect an air pressure change, a change in wind noise, or a combination thereof, thereby determining the movement that extends the mobile device from inside the vehicle to outside the vehicle. In this instance, the mobile device is moved outside the vehicle before an image recording mode is initiated on the mobile device. As another instance, the map incident/feature module 305 can process the sensor data to detect an activation of an image recording device of the mobile device. The detecting of the map incident, the map feature, or a combination thereof is further based on the detected activation of the image recording device. By way of example, the action of “extending the arm away from the body” (similar to extending the arm out of the window of a vehicle) by the user and/or by the people around the user to capture the spontaneous event, is a significant action related to and in conjunction with the UE's orientation changes. The map incident/feature module 305 can be triggered to analyze the area for detecting/verifying the spontaneous event.

In another embodiment, the map incident/feature module 305 can process location data and image capturing enablement data collected by sensors of one or more mobile devices moving in a geographic area (e.g., ˜5:00 pm at Time Square of New York City) to determine that the one or more mobile devices are located in proximity with each other while capturing image data within a predetermined time period. By way of example, the image capturing enablement data can include image/video capturing mode enablement timing, camera heading, exposure, light sensitivity, a shutter speed, an auto/manual mode, color profile settings, etc.

Upon determining that an amount of the capturing enablement image data exceeds an amount of historical baseline image capturing enablement data by a threshold, the map incident/feature module 305 can process the image data to detect a map incident (e.g., a protest), a map feature (e.g., a new statute), or a combination thereof occurring within the proximity of the one or more mobile devices. In one instance, the map incident/feature module 305 can process the image data using computer vision, machine learning, artificial intelligence, or a combination thereof to recognize the map incident, the map feature, or a combination thereof.

In another instance, the map incident/feature module 305 can adjust the threshold based on a historical traffic level, a current traffic level, or a combination thereof within the proximity of the one or more mobile devices. In other words, the map incident/feature module 305 can dynamically change the incident detection sensitively based on location (e.g., a type of road, a functional class level, etc.), a number of other vehicles/pedestrians/devices in the area at that time, etc., by adjusting the threshold. By way of example, the map incident/feature module 305 can detect a traffic incident on a rural road than near a tourist attraction with a much lower threshold, even using data from one mobile device.

As another instance, the map incident/feature module 305 can determine an orientation change for each of the mobile devices based on the image capturing enablement, and determine a location of the orientation change based on the image capturing enablement data. The detecting of the map incident, the map feature, or a combination thereof is further based on the orientation change. Additionally or alternatively, the map incident/feature module 305 can determine an amount of typing/texting/calls/social media posts (e.g., for a highway closure over 30 minutes) increase more than a historical amount to trigger map incidents/feature detection.

In another embodiment, the map incident/feature module 305 can combine various static and dynamic location-based sensor data and context data to train a map incident/feature detection model (e.g., a machine learning model) in order to generate a model which increases the accuracy and minimizes the time for detecting map incidents/features.

The static and dynamic location-based sensor data may include user device attributes (e.g., models, weights, sizes, sensor attributes, camera attributes, etc.), driver attributes (e.g., area familiarity, mobility patterns, work schedules, etc. of a driver), passenger attributes (e.g., preference data, with special needs or not, etc.), location attributes (e.g., operation/concierge hours, entry/exit locations, ramps, stairs, elevators, etc.), vehicle attributes (e.g., models, weights, sizes, maneuverability, origins/destinations, mobility graphs, etc. of the vehicle 103), traffic attributes (e.g., speeds, traffic flows, etc.), road attributes (e.g., road dimensions, shapes, directionality, lane attributes, etc.), weather attributes (e.g., line of sight/visibility, surface slippery or not, etc.), population density, etc.

In one embodiment, the static and dynamic location-based sensor data may be retrieved from various local and/or external databases. By way of example, the map incident/feature module 305 can obtain the location attributes, the traffic attributes, the road attributes, etc. from a geographic database 113.

As such, the map incident/feature module 305 can use a trained machine learning model to look for a cluster with the most similar features/attributes as the new area. Then, the map incident/feature module 305 can detect new map incident/feature based on sensor data directly, without going via the process 400.

In one embodiment, the verification module 307 can initiate a verification of a previously observed map incident, a previously observed map feature, or a combination thereof based on the detected map incident, the detected map feature, or a combination thereof, based on other information sources of map incident/feature data. The output module 309 can then update digital map data of a geographic database based on the verification. By way of example, the output module 309 can generate an alert of approaching a camera-worthy incident, an alert of a potential hazard for drivers approaching a firework event area because of the distraction of the fireworks, etc., even though there is no change in traffic flow.

In one embodiment, the verification module 307 can subject the extracted data to a number of threshold criteria stored within the sensor database 111, the geographic databases 113, or a combination thereof, including a correctness probability, a level of confidence, a degree of trust, a rating, or a combination thereof. Once the candidate map incident/feature reaches one or more threshold criteria, the map incident/feature is considered accurate and valid and can then be propagated to the mapping/location-based services. In addition or alternatively, the verification module 307 may provide a list of candidate map incident/feature for manual verification.

In one embodiment, the verification module 307 can apply blockchain technology to verify map incidents/features, localize vehicles/cargos, and optimize routes, after verifying the orientation changes.

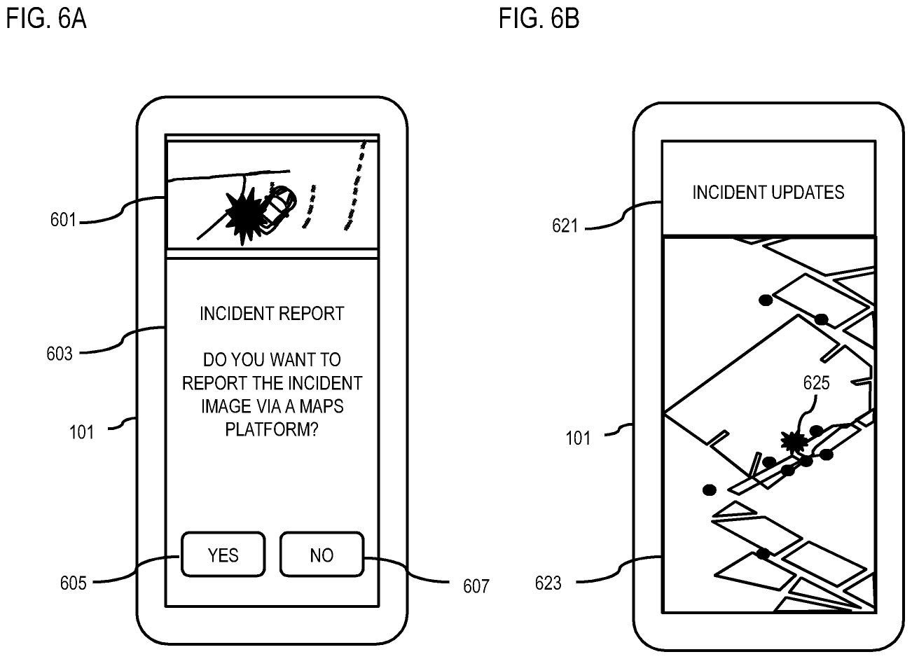

In one embodiment, the output module 309 can provide data for presenting the detected map incident, the detected map feature, or a combination thereof in an alert user interface, a mapping user interface, or a combination thereof. FIGS. 6A and 6B are diagrams of example user interfaces for providing mapping and/or navigation services based on detected map incidents/features, according to various embodiments. In FIG. 6A, a user interface of the UE 101 shows a captured image 601 of a map incident (e.g., a traffic accident), an incident reporting instruction 603, a YES button 605, and a NO button 607. By way of example, the incident reporting instruction 603 prompts a statement: “Do you want to report the incident image via a maps platform?” The maps platform 109 can process the image in conjunction with orientation change data as discussed with respect to FIGS. 3-5 above, to detect/verify one or more map incidents/features and support location-based services (e.g., a navigation service). In FIG. 6B, a user interface of the UE 101 shows a title 621 of Incident Updates, and a navigation map 623 depicting a traffic accident 625.

In another embodiment, the incident reporting instruction 603 prompts a statement: “Do you want to share the incident image via a social network?” The maps platform 109 can process the image in conjunction with user device interaction activity data and orientation change data as discussed with respect to FIGS. 3-5 above, to detect/verify one or more map incidents/features and support location-based services.

The above-discussed embodiments detect and/or verify map incidents (e.g., traffic accidents) and/or map features (e.g., POIs), using sensor data, probe data, probe analysis, blockchain technology, routing API, LiDAR, solar cells, historical and real time location data, cloud and edge computing, computer vision, machine learning, artificial intelligence, etc., to support mapping services, navigation servicers, autonomous driving services, ride-hailing services, ride-sharing services, social networking services, IoT, IIoT, etc.

Returning to FIG. 1, the UEs 101 may be a personal navigation device (“PND”), a cellular telephone, a mobile phone, a personal digital assistant (“PDA”), a watch, a camera, a computer, an in-vehicle or embedded navigation system, and/or other device that is configured with multiple sensors types that can be used for join motion detection according to the embodiments described herein. It is contemplated, that the cellular telephone or other wireless communication device may be interfaced with an on-board navigation system of an autonomous vehicle or physically connected to the vehicle 103 for serving as the navigation system. Also, the UEs 101 and/or vehicles 103 may be configured to access the communication network 115 by way of any known or still developing communication protocols. Via this communication network 115, the UEs 101 and/or vehicles 103 may transmit sensor data collected from multiple different sensor types 105 for facilitating joint motion detection.

The UEs 101 and/or vehicles 103 may be configured with multiple sensors 105 of different types for acquiring and/or generating sensor data according to the embodiments described herein. For example, sensors 105 may be used as GPS or other positioning receivers for interacting with one or more location satellites to determine and track the current speed, position, and location of a UE 101. In addition, the sensors 105 may gather IMU data, NFC data, Bluetooth data, acoustic data, barometric data, orientation data (e.g., a degree of origination change of the UE 101 during travel), motion data, light data, sound data, image data, weather data, temporal data and other data associated with the vehicle and/or UEs 101 thereof. Still further, the sensors 105 may detect local or transient network and/or wireless signals, such as those transmitted by nearby devices during navigation of a vehicle along a roadway. This may include, for example, network routers configured within a premise (e.g., home or business), another UE 101 or vehicle 103 or a communicable traffic system (e.g., traffic lights, traffic cameras, traffic signals, digital signage). In one embodiment, the maps platform 109 aggregates multiple sensor data gathered and/or generated by the UEs 101 and/or vehicles 103 resulting from traveling.

By way of example, the maps platform 109 may be implemented as a cloud-based service, hosted solution, or the like for performing the above described functions. Alternatively, the maps platform 109 may be directly integrated for processing data generated and/or provided by the service platform 117, one or more services 119, and/or content providers 121. Per this integration, the maps platform 109 may perform client-side state computation of orientation change data.

By way of example, the communication network 115 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

A UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that a UE 101 can support any type of interface to the user (such as “wearable” circuitry, etc.).

By way of example, the UE 10s, the maps platform 109, the service platform 117, and the content providers 121 communicate with each other and other components of the communication network 115 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

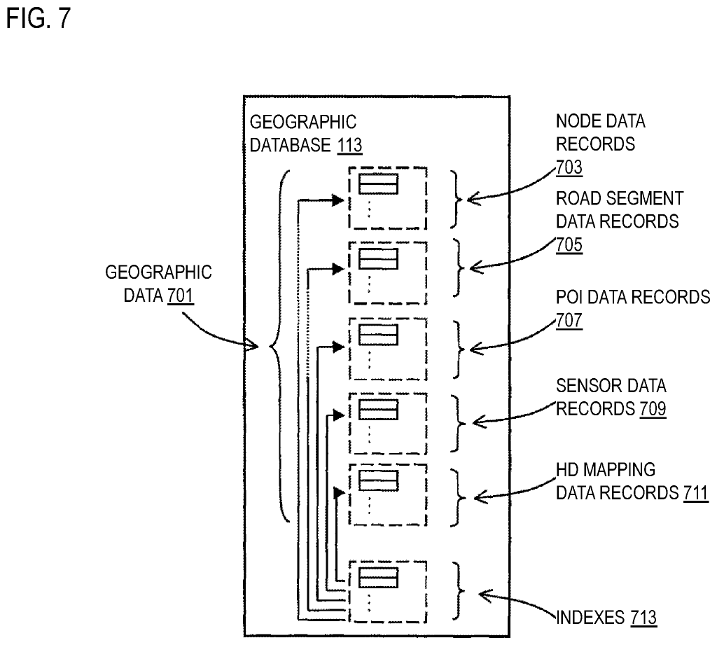

FIG. 7 is a diagram of a geographic database (such as the database 113), according to one embodiment. In one embodiment, the geographic database 113 includes geographic data 701 used for (or configured to be compiled to be used for) mapping and/or navigation-related services, such as for video odometry based on the parametric representation of lanes include, e.g., encoding and/or decoding parametric representations into lane lines. In one embodiment, the geographic database 113 include high resolution or high definition (HD) mapping data that provide centimeter-level or better accuracy of map features. For example, the geographic database 113 can be based on Light Detection and Ranging (LiDAR) or equivalent technology to collect billions of 3D points and model road surfaces and other map features down to the number lanes and their widths. In one embodiment, the HD mapping data (e.g., HD data records 711) capture and store details such as the slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 113.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 113 follows certain conventions. For example, links do not cross themselves and do not cross each other except at a node. Also, there are no duplicated shape points, nodes, or links. Two links that connect each other have a common node. In the geographic database 113, overlapping geographic features are represented by overlapping polygons. When polygons overlap, the boundary of one polygon crosses the boundary of the other polygon. In the geographic database 113, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 113 includes node data records 703, road segment or link data records 705, POI data records 707, sensor data records 709, HD mapping data records 711, and indexes 713, for example. More, fewer, or different data records can be provided. In one embodiment, additional data records (not shown) can include cartographic (“cartel”) data records, routing data, and maneuver data. In one embodiment, the indexes 713 may improve the speed of data retrieval operations in the geographic database 113. In one embodiment, the indexes 713 may be used to quickly locate data without having to search every row in the geographic database 113 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or recorded route information for determination of one or more personalized routes. The node data records 703 are end points corresponding to the respective links or segments of the road segment data records 705. The road link data records 705 and the node data records 703 represent a road network, such as used by vehicles, cars, and/or other entities. Alternatively, the geographic database 113 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 113 can include data about the POIs and their respective locations in the POI data records 707. The geographic database 113 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city).

In one embodiment, the geographic database 113 can also include sensor data records 709 for storing sensor data, mobile device orientation change data, detected/verified map incident/feature data, training data, prediction models, annotated observations, computed featured distributions, sampling probabilities, and/or any other data generated or used by the system 100 according to the various embodiments described herein. By way of example, the sensor data records 709 can be associated with one or more of the node records 703, road segment records 705, and/or POI data records 707 to support localization or visual odometry based on the features stored therein and the corresponding estimated quality of the features. In this way, the records 709 can also be associated with or used to associate the characteristics or metadata of the corresponding records 703, 705, and/or 707.

In one embodiment, as discussed above, the HD mapping data records 711 model road surfaces and other map features to centimeter-level or better accuracy. The HD mapping data records 711 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the HD mapping data records 711 are divided into spatial partitions of varying sizes to provide HD mapping data to vehicles 103 and other end user devices with near real-time speed without overloading the available resources of the vehicles 103 and/or devices (e.g., computational, memory, bandwidth, etc. resources).

In one embodiment, the HD mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 711.

In one embodiment, the HD mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 113 can be maintained by the content provider 121 in association with the services platform 117 (e.g., a map developer). The map developer can collect geographic data to generate and enhance the geographic database 113. There can be different ways used by the map developer to collect data. These ways can include obtaining data from other sources, such as municipalities or respective geographic authorities. In addition, the map developer can employ field personnel to travel by vehicle (e.g., UE 101 and/or vehicles 103) along roads throughout the geographic region to observe features and/or record information about them, for example. Also, remote sensing, such as aerial or satellite photography, can be used.

The geographic database 113 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 103 or a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for detecting location-based events and/or points of interest based on mobile device orientation changes may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

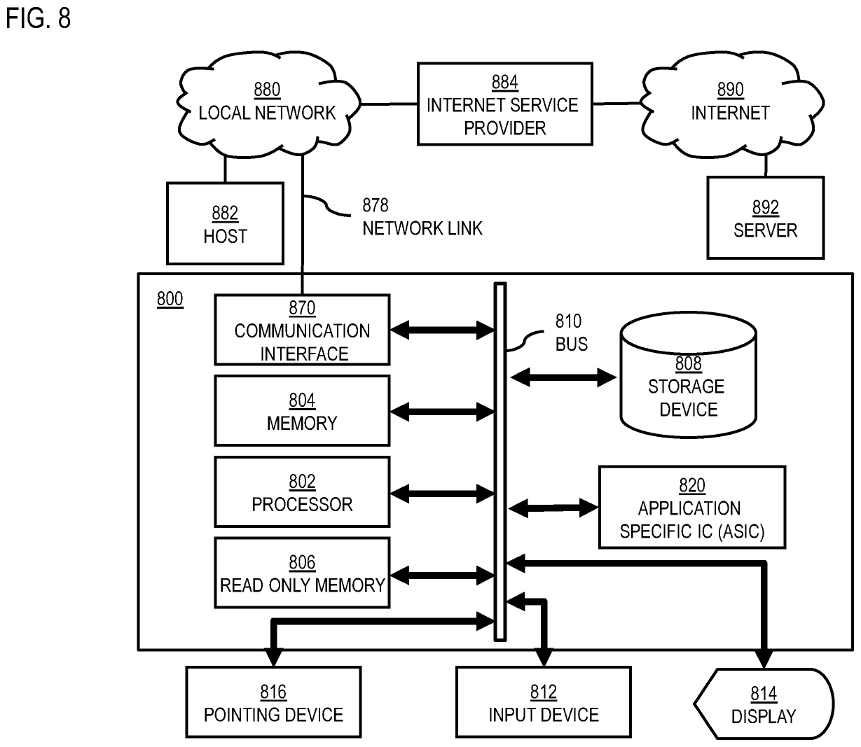

FIG. 8 illustrates a computer system 800 upon which an embodiment of the invention may be implemented. Computer system 800 is programmed (e.g., via computer program code or instructions) to detect location-based events and/or points of interest based on mobile device orientation changes as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to detecting location-based events and/or points of interest based on mobile device orientation changes. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RANI) or other dynamic storage device, stores information including processor instructions for detecting location-based events and/or points of interest based on mobile device orientation changes. Dynamic memory allows information stored therein to be changed by the computer system 800. RANI allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk, or flash card, for storing information, including instructions, that persists even when the computer system 800 is turned off or otherwise loses power.

Information, including instructions for detecting location-based events and/or points of interest based on mobile device orientation changes, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners, and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic, or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 by the UE 101 for detecting location-based events and/or points of interest based on mobile device orientation changes.

The term computer-readable medium is used herein to refer to any medium that participates in providing information to processor 802, including instructions for execution. Such a medium may take many forms, including, but not limited to, non-volatile media, volatile media, and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to detect location-based events and/or points of interest based on mobile device orientation changes as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to detect location-based events and/or points of interest based on mobile device orientation changes. The memory 905 also stores the data associated with or generated by the execution of the inventive steps.

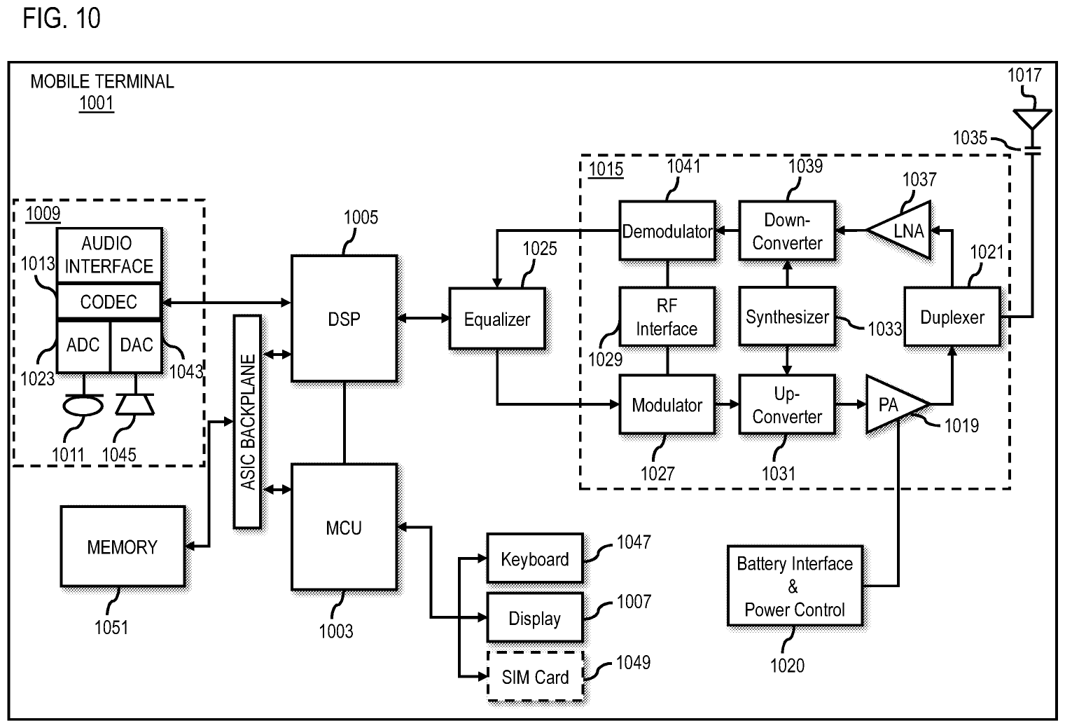

FIG. 10 is a diagram of exemplary components of a mobile terminal 1001 (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to detect location-based events and/or points of interest based on mobile device orientation changes. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining an orientation change of a mobile device moving in a geographic area based on sensor data collected from one or more sensors of the mobile device;
determining a location of the orientation change based on the sensor data; and
detecting a map incident, a map feature, or a combination occurring within a proximity of the location based on the orientation change.

2. The method of claim 1, further comprising:
initiating a verification of a previously observed map incident, a previously observed map feature, or a combination thereof based on the detected map incident, the detected map feature, or a combination thereof; and
updating digital map data of a geographic database based on the verification.

3. The method of claim 1, further comprising:
processing the sensor data to detect an activation of an image recording device of the mobile device,
wherein the detecting of the map incident, the map feature, or a combination thereof is further based on the detected activation of the image recording device.

4. The method of claim 1, wherein the mobile device is carried in a vehicle, the method further comprising:
processing the sensor data to filter a vehicle movement of the vehicle from a user movement of a user of the mobile device as a cause of the orientation change,
wherein the detecting of the map incident, the map feature, or a combination thereof is based on the orientation change resulting from the user movement.

5. The method of claim 1, further comprising:
processing the sensor data to detect an alignment of the mobile device with respect to a plane of a window of a vehicle carrying the mobile device,
wherein the detecting of the map incident, the map feature, or a combination is further based on the detected alignment.

6. The method of claim 1, further comprising:
processing the sensor data to detect a movement that extends the mobile device from inside a vehicle to outside the vehicle before initiating an image recording mode on the mobile device,
wherein the detecting of the map incident, the map feature, or a combination thereof is further based on the detected movement.

7. The method of claim 1, further comprising:
processing the sensor data to detect an air pressure change in combination with the orientation change,
wherein the detecting of the map incident, the map feature, or a combination thereof is further based on the detected air pressure change.

8. The method of claim 1, further comprising:
processing the sensor data to detect a change in wind noise in combination with the orientation change,
wherein the detecting of the map incident, the map feature, or a combination thereof is further based on the detected change in wind noise.

9. The method of claim 1, further comprising:
processing the sensor data to detect a change in user interaction activity data with the mobile device in combination with the orientation change,
wherein the detecting of the map incident, the map feature, or a combination thereof is further based on the detected user interaction activity data.

10. The method of claim 1, wherein the determining of the location of the orientation change is further based on a direction, a focal point, or a combination thereof of the orientation change.

11. The method of claim 1, wherein the detecting of the map incident, the map feature, or a combination thereof is further based on orientation change data collected from one or more other mobile devices moving with a threshold proximity, a threshold time period, or a combination thereof.

12. The method of claim 1, wherein the detected map incident includes a traffic incident.

13. The method of claim 1, wherein the detected map incident, the detected map feature, or a combination thereof relates to indoor mapping.

14. The method of claim 1, further comprising:
providing data for presenting the detected map incident, the detected map feature, or a combination thereof in an alert user interface, a mapping user interface, or a combination thereof.

15. An apparatus comprising:
at least one processor; and
at least one memory including computer program code for one or more programs,
the at least one memory and the computer program code configured to, with the at least one processor, cause the apparatus to perform at least the following,
process sensor data collected by one or more sensors of a mobile device moving in a geographic area, to detect at least one of:
(1) an alignment of the mobile device with respect to a plane of a window of a vehicle carrying the mobile device,
(2) a movement that extends the mobile device from inside the vehicle to outside the vehicle;
determine a location of the alignment, the movement, or a combination thereof based on the sensor data; and
detect a map incident, a map feature, or a combination occurring within a proximity of the location based on the alignment, the movement, or a combination thereof.

16. The apparatus of claim 15, wherein the apparatus is further caused to:
process the sensor data to detect an air pressure change, a change in wind noise, or a combination thereof, thereby determining the movement extending the mobile device outside the vehicle,
wherein the mobile device is moved outside the vehicle before an image recording mode is initiated on the mobile device.

17. The apparatus of claim 15, wherein the apparatus is further caused to:
process the sensor data to detect an activation of an image recording device of the mobile device,
wherein the detecting of the map incident, the map feature, or a combination thereof is further based on the detected activation of the image recording device.

18. A non-transitory computer-readable storage medium carrying one or more sequences of one or more instructions which, when executed by one or more processors, cause an apparatus to at least perform the following steps:
processing location data and image capturing enablement data collected by sensors of one or more mobile devices moving in a geographic area to determine that the one or more mobile devices are located in proximity with each other while capturing image data within a predetermined time period;
upon determining that an amount of the image capturing enablement data exceeds an amount of historical baseline image capturing enablement data by a threshold, processing the image data to detect a map incident, a map feature, or a combination thereof occurring within the proximity of the one or more mobile devices.

19. The non-transitory computer-readable storage medium of claim 18, wherein the apparatus is caused to further perform:
processing the image data using computer vision, machine learning, artificial intelligence, or a combination thereof to recognize the map incident, the map feature, or a combination thereof, and
adjusting the threshold based on a historical traffic level, a current traffic level, or a combination thereof within the proximity of the one or more mobile devices.

20. The non-transitory computer-readable storage medium of claim 18, wherein the apparatus is caused to further perform:
determining an orientation change for each of the one or more mobile devices based on the capturing enablement data; and
determining a location of the orientation change based on the capturing enablement data,
wherein the detecting of the map incident, the map feature, or a combination thereof is further based on the orientation change.
